(19) United States
(12) Patent Application Publication
(10) Pub. No.: US 2023/0001870 A1
(43) Pub. Date: Jan. 5, 2023

(54) VEHICLE BEAM COMPONENT AND ASSEMBLY

(71) Applicant: Shape Corp., Grand Haven, MI (US)

(72) Inventors: Joseph R. Matecki, Allendale, MI (US); Jeffrey A. McHenry, Norton Shores, MI (US); Matthew Kuipers, Zeeland, MI (US); Kannan Ramamoorthy, Holland, MI (US)

(21) Appl. No.: 17/810,806

(22) Filed: Jul. 5, 2022

Related U.S. Application Data
(60) Provisional application No. 63/217,856, filed on Jul. 2, 2021.
(60) Provisional application No. 63/267,336, filed on Jan. 31, 2022.

(51) Int. Cl. B60R 19/34

(52) U.S. Cl. CPC B60R 19/34; B60R 2019/1806

(57) ABSTRACT

A vehicle beam assembly includes a hollow tubular member configured to be formed with steel tube air forming. The tubular member includes a varied cross section along a length of the tubular member. For example, the hollow tubular member includes a center portion having a first cross-sectional shape, a pair of end portions that extend past corresponding crush cans in a direction away from the center portion, where the pair of end portions extend at an angle of 40-70 degrees, and at least one transition portion disposed between the center portion and one of the pair of end portions. A cross-sectional shape of the center portion, a cross sectional shape of one of the end portions, and a cross-sectional shape of the transition portion are all different cross-sectional shapes.

### CROSS-REFERENCE TO RELATED APPLICATIONS

This application claims benefit and priority under 35 U.S.C. § 119(e) to U.S. Provisional Patent Application No. 63/217,856, filed Jul. 2, 2021, and to U.S. Provisional Patent Application No. 63/267,336, filed Jan. 31, 2022, the contents of these prior applications are considered part of this application and are hereby incorporated by reference in their entireties.

### TECHNICAL FIELD

The present disclosure generally relates to a vehicle beam component, and more specifically relates to a tubular beam with a hollow interior, such as for use as a vehicle bumper reinforcement, a structural frame component, a battery tray component, or the like.

### BACKGROUND

Vehicle components are typically designed for a specific vehicle model specification with efforts to efficiently conserve and reduce mass and to meet vehicle impact and safety requirements. For example, it is known that the cross-sectional shape of a vehicle beam used as a bumper beam or structural component is generally continuous along the length of the vehicle beam and is designed to have a shape that corresponds with the desired packaging space, bending strength, and impact energy management characteristics. In the case of roll formed or stamped vehicle beams, the weld location on the cross-sectional shape can impact the component's performance. Also, different materials and manufacturing processes provide vehicle beam design constraints that are considered along with costs. One known manufacturing process is hot metal gas forming that is capable of forming high strength steel in a closed die with pressurized air blown into the interior of a steel tube. Nonetheless, vehicle beams for structural components including rockers, bumper beams, and battery tray components are susceptible to improvements that may enhance their overall performance and cost.

### SUMMARY

One aspect of the disclosure provides a vehicle beam assembly that has a hollow tubular beam that is formed with a steel tube air forming process. The vehicle beam assembly includes a pair of crush cans configured to be coupled to a vehicle frame and a hollow tubular member that is coupled to the crush cans. The tubular member includes a varied cross section along a length of the tubular member. The hollow tubular member includes a center portion having a first cross-sectional shape and a pair of end portions that extend outward from the crush cans in a direction away from the center portion, such as at an angle of 40-70 degrees. Additionally, at least one transition portion disposed between the center portion and one of the pair of end portions, and a cross-sectional shape of the center portion, a cross sectional shape of one of the end portions, and a cross-sectional shape of the transition portion are all different cross-sectional shapes.

Another aspect of the disclosure provides a vehicle beam assembly component that is configured to be formed with steel tube air forming. The vehicle beam assembly component includes a hollow tubular member having an integrated flange extending along a length of the tubular member. Additionally, the integrated flange includes a folded seem defined by abutting interior surfaces of adjacent wall sections of the tubular member. Moreover, the folded seem terminates at an edge of the integrated flange where the adjacent wall sections integrally interconnect.

Yet another aspect of the disclosure provides a vehicle beam assembly component that includes a hollow tubular member configured to be formed with a steel tube air forming process. The tubular member includes a varied cross section along a length of the tubular member. The hollow tubular member includes a center portion having a first cross-sectional shape, a pair of end portions that extend outward from the center portion, and at least one transition portion disposed between the center portion and one of the pair of end portions. A cross-sectional shape of the center portion, a cross sectional shape of one of the end portions, and a cross-sectional shape of the transition portion are all different cross-sectional shapes. The tubular member comprises an integrated flange disposed along the length of the tubular beam, where the integrated flange comprises a folded seem defined by abutting interior surfaces of adjacent wall sections of the tubular member. The folded seem may terminate at an edge of the integrated flange where the adjacent wall sections integrally interconnect.

Implementations of the disclosure may include one or more of the following optional features. In some examples, the hollow tubular member is formed from a high-strength steel.

In some examples, the end portions of the tubular member are formed with a narrowed depth relative to the center portion of the tubular member.

In some examples, the tubular member includes integrally formed crush can attachment features at select end portions of the tubular member. In some implementations, the attachment features includes recessed areas at a back side of the vehicle beam assembly component to receive the crush cans.

In some examples, the tubular member includes an integral flange adjacent to the recessed areas, such that the integral flange may be disposed against the crush can for providing a weld interface.

In some examples, the cross-sectional shapes of the tubular member at the end portions and center portion each include a rear wall portion, an upper wall portion, a lower wall portion, and a lower wall portion that interconnect with each other.

In some examples, the cross-sectional shape of the end portion includes a C shape and the cross-sectional shape of the center portion includes a B shape.

In some examples, the cross-sectional shape of the end portion includes a B shape and the cross-sectional shape of the center portion includes a D shape.

In some examples, the tubular member comprises a battery tray component or a rocker component.

In some examples, the pair of end portions extend at an angle of approximately 50-60 degrees.

In some examples, the tubular member includes local deformation at a select section along the length of the beam. In some implementations, the local deformation includes a crush initiator configured to cause the tubular member to deform as a hinge and provide a resulting shape of the tubular member after crash that is substantially planar after contacting an object.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 shows a top view of a vehicle beam assembly component and a force deflection chart corresponding to a roll formed vehicle beam assembly component have a constant cross-sectional shape.

FIG. 2A is a perspective view of a vehicle beam assembly component.

FIG. 2B is a front elevation view of the vehicle beam assembly component of FIG. 2A.

FIG. 2C is another perspective view of the vehicle beam assembly component of FIG. 2A.

FIG. 2D is a cross-sectional view of an end portion of the vehicle beam assembly component taken at line D-D shown in FIG. 2C.

FIG. 2E is a cross-sectional view of a center portion of the vehicle beam assembly component taken at line E-E shown in FIG. 2C.

FIG. 3 shows a top view and cross section views of an example of a bumper assembly with a tubular member having a B-D-B variable cross section profile along its length and transition zones between the profile shapes.

FIG. 4 is a top plan view of a partial bumper assembly in a vehicle environment having a tubular member with a reduced section depth at the end portions.

FIG. 5A is a top plan view of a partial bumper assembly having a tubular member with a reduced section depth at the end portions to provide added space for crush can compression.

FIG. 5B is an enlarged top plan view of the vehicle beam assembly component of FIG. 5A.

FIG. 6 is a perspective end view of a bumper assembly and a cross section view of the tubular member showing a smooth rear surface for welding the crush can at the rear surface.

FIG. 7 shows side and perspective views of a bumper assembly having an increased interface for the crush can.

FIG. 8 is a cross section view of a vehicle beam assembly component having a weld in a valley between two hollow sections after the air forming process.

FIG. 9A is a perspective view of another example of a vehicle beam assembly component.

FIG. 9B is a top plan view of the vehicle beam assembly component of FIG. 9A.

FIG. 9C is a front elevation view of the vehicle beam assembly component of FIG. 9A.

FIG. 9D is a cross-sectional view of an end portion of the vehicle beam assembly component taken at line D-D shown in FIG. 9C.

FIG. 9E is a cross-sectional view of a center portion of the vehicle beam assembly component taken at line E-E shown in FIG. 9C.

FIG. 10 shows partial rear and perspective views of a vehicle beam assembly component and a MPDB barrier overlapping the taller end section of the vehicle beam assembly component.

FIG. 11A is a perspective view of another example of a vehicle beam assembly component.

FIG. 11B is a top plan view of the vehicle beam assembly component of FIG. 11A.

FIG. 11C is a rear elevation view of the vehicle beam assembly component of FIG. 11A.

FIG. 11D is a cross-sectional view of an end portion of the vehicle beam assembly component taken at line D-D shown in FIG. 11C.

FIG. 11E is a cross-sectional view of a center portion of the vehicle beam assembly component taken at line E-E shown in FIG. 11C.

FIG. 12A is a perspective view of yet another example of a vehicle beam assembly component.

FIG. 12B is a top plan view of the vehicle beam assembly component of FIG. 24.

FIG. 12C is a rear elevation view of the vehicle beam assembly component of FIG. 24.

FIG. 12D is a cross-sectional view of an end portion of the vehicle beam assembly component taken at line D-D shown in FIG. 12C.

FIG. 12E is a cross-sectional view of a center portion of the vehicle beam assembly component taken at line E-E shown in FIG. 12C.

FIG. 13 shows cross section views of a vehicle beam assembly component at the crush can interface before and after a crash and a force deflection chart for the corresponding crash.

FIG. 14 shows cross section views of vehicle beam assembly components with B-shaped and C-shaped cross sections at the crush can interfaces before and after a crash and force deflection charts for the corresponding cross sections.

FIG. 15A shows rear perspective views of a vehicle beam assembly component prior to being formed and a bumper assembly having a formation that engages a front end of a crush can.

FIG. 15B shows cross section views of the bumper assembly of FIG. 15A to show the formation that engages the front end of a crush can.

FIG. 16 shows perspective and cross section views of a vehicle beam assembly component having a tow bushing attached to the vehicle beam assembly component with front and rear plates.

FIG. 17 shows perspective and cross section views of a vehicle beam assembly component having a tow bushing attached through integral flanges of the beam.

FIG. 18 is a perspective view of a vehicle beam assembly component having two flange brackets.

FIG. 19 is a perspective view of a vehicle beam assembly component having an integrated flange centrally located on the vehicle beam assembly component that replaces two brackets from the vehicle beam assembly component shown in FIG. 18.

FIG. 20 is a side view of a vehicle beam assembly component and surrounding vehicle body structure.

FIG. 21 is a side view of a vehicle beam assembly component with a local formation at the rear of the beam to provide a larger relief area between the vehicle beam assembly component and the vehicle body structure.

FIG. 22 shows side views of a vehicle beam assembly component interacting with an impactor and the resulting deformation to the vehicle beam assembly component.

FIG. 23 shows side views of a vehicle beam assembly component interacting with an impactor, where the shape of the vehicle beam assembly component is tailored to control the deformation during impact.

FIG. 24 shows top views of a vehicle beam assembly component that allows for clearance for local components and packaging needs.

FIG. 25 shows top views of a vehicle beam assembly component interacting with an impactor, where the vehicle beam assembly component has a single hinge failure.

FIG. 26 shows top views of a vehicle beam assembly component interacting with an impactor, where the shape of the vehicle beam assembly component controls the impact deformation with a double hinge configuration.

FIG. 27 is a chart that compares the force and the deflection of the vehicle beam assembly components shown in FIGS. 25 and 26.

FIG. 28 shows cross section views of cross members for a vehicle battery tray having integrated features with a narrow width and an integrated top fastener.

FIG. 29 shows cross section, side, and top views of concepts for a battery tray frame that incorporates a vehicle beam assembly component having an integrated flange, altered sizes along the lengths, and variable cross sections.

FIG. 30 shows perspective, top, and cross section views of concepts for cross members with expanded ends, rockers with integrated flanges, and rockers with integrated features that enable crash load paths.

Like reference numerals indicate like parts throughout the drawings.

### DETAILED DESCRIPTION

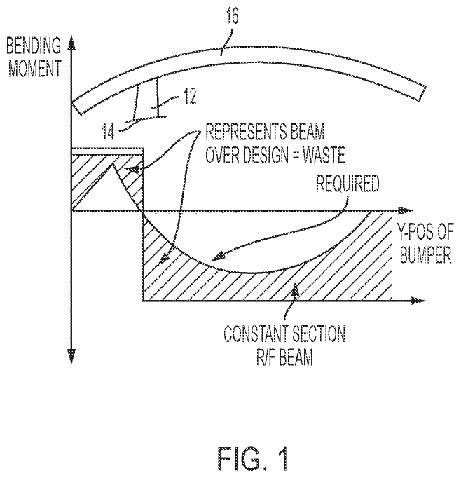

As shown in FIG. 1, a vehicle beam assembly component 10 includes crush cans 12 that support end portions of the vehicle beam assembly component 10 at a frame 14 of a vehicle, such as to extend generally longitudinally on the vehicle between the back side of a bumper beam 16 and the rail tips of the vehicle frame. In other examples, the vehicle beam assembly 10 is a component for a vehicle battery tray or a vehicle rocker. Vehicles and vehicle components are typically subject to multiple crash tests during vehicle development. Various crash tests test various features of the vehicle and components at different speeds, angles, and impact objects, so as to provide energy absorption and corresponding ratings for each crash test. In some examples, a frontal crash test provides a front impact that measures the energy absorption of a vehicle beam assembly component 10 and the supporting crush cans 12. In one example, such as the example shown in FIG. 1, the vehicle beam assembly component 10 and the crush cans 12 are configured to absorb impact energy before substantial deformation or damage is done to the vehicle frame, such that the design and length of the crush can 12 and the cross-sectional shape of the vehicle beam assembly component 10 can alter the impact energy absorption, as shown on the force-displacement graph of the crash event.

In addition, vehicle crash tests include a Mobile Progressive Deformable Barrier (MPDB) test. This test replicates a head-on collision between two oncoming cars at moderately high speeds. In most collisions of this type, only a part of the vehicle front width structure is involved, i.e. the two colliding vehicles are laterally offset. In the full-scale MPDB test, the test vehicle is driven at 50 km/h and with 50 percent overlap into a deformable barrier also travelling at 50 km/h. The barrier represents the front end of another vehicle, getting progressively stiffer the more it is deformed. The test replicates a crash between the test vehicle and a typical mid-size car. It has been found that a beam component having a sharp edge or corner does not give the desired results of the MPDB test. Also, beam components having a relatively small height at the section contacting the barrier do not perform well in this test.

Referring now to the drawings and the illustrative examples depicted therein, a vehicle beam assembly is provided with at least one beam component that is formed with a process that involves hot metal gas forming or steel tube air forming (STAF). Traditionally, high strength beams formed in roll form mills have design constraints based on the hardness or ductility of the metal and typically have a consistent cross-sectional shape along the length of the beam. In some examples of the disclosure, the vehicle beam assembly may include a hollow tubular member that has a flange extending along a length of the tubular member, where the flange includes a folded seem defined by abutting interior surfaces adjacent wall sections of the tubular member. The folded seem terminates at an edge of the flange where the adjacent wall sections integrally interconnect. In some examples, the flange can include a different size and different position along the length of the beam. Such a flange is generally not capable of being formed with the same material in a roll forming process. Moreover, in some examples, the vehicle beam assembly may include a hollow tubular member with a varied cross section along its length, such as to provide a cross section tailored for the crash impact energy demands, packaging constraints, and accessory attachments at the corresponding section of the length.

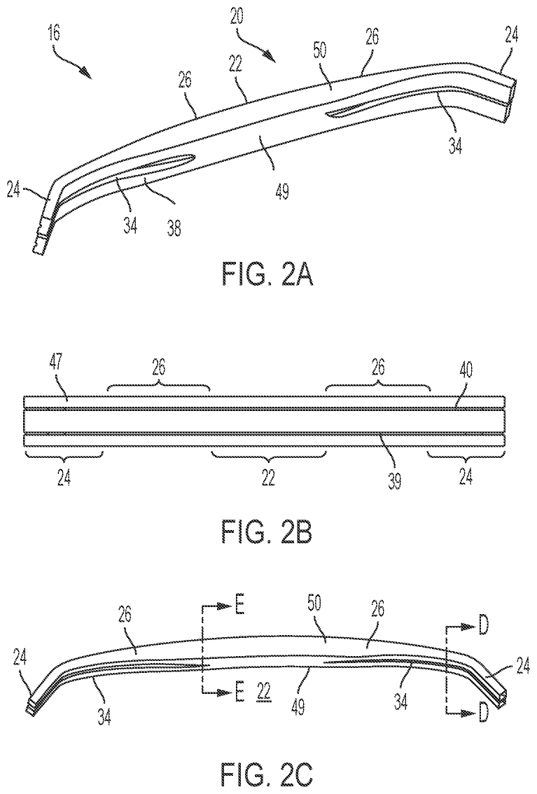

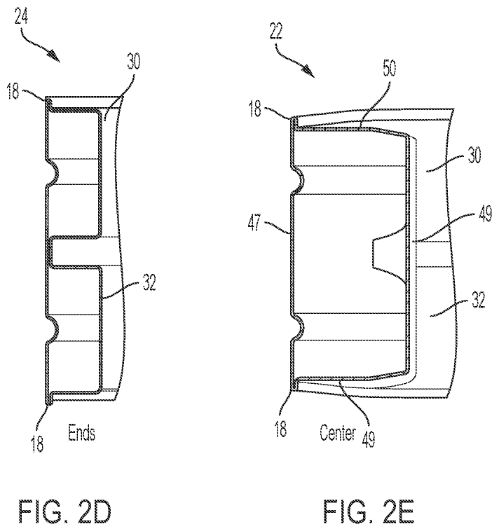

As shown in FIGS. 2A-2E, the vehicle beam assembly component 10 is provided that has a hollow tubular member 20, which in some examples may also be referred to as a bumper beam.

The hollow tubular member 20 has a varied cross section along its length that is produced by a steel tube air forming (STAF) process. In some examples, the STAF process includes resistance heating, high pressure air injection, forming and hardening. This process makes it possible to perform the integrated forming of the tubular member 20 and a flange 18, unlike traditional welding methods, the STAF system improves rigidity and simplifies the overall production process. The STAF process allows for a varied cross section along a single tubular member 20 and also results in a component that has a high strength and high rigidity. While varied cross sectional shapes can be obtained other ways, including but not limited to hot stamping, cold pressing, and hydroforming, each of these result in a component having either low strength, low rigidity, or both.

Referring now to the drawings and the illustrative examples depicted therein, a vehicle beam assembly component 10 may include a pair of crush cans 12 configured to be coupled to a vehicle frame and a tubular member 20 configured to be coupled to the pair of crush cans 12. The crush cans 12 are coupled with and support end portion 24 of the tubular member 20 at a frame of a vehicle 10, such as to extend generally longitudinally on the vehicle between the back side of the tubular member 20 and the rail tips of the vehicle frame. In the example shown in FIG. 2, the crush cans 12 are approximately equidistant from a vertical centerline of the tubular member 20. However, in other examples, the crush cans 12 may be offset from being equidistant from the vertical centerline of a tubular member 20. Additionally, the end portion 24 of the tubular member 20 extend horizontally past the crush cans 12 and curve rearward, such as to reduce sharp corners or edges of the tubular member 20 that may contact the impacted object near the crush can. The crush cans 12 and the tubular member 20 may include a coupling plate or other coupling portions therebetween to assist in the coupling between the crush cans 12 and the tubular member 20. However, it is also contemplated that the crush cans 12 may be directly coupled to the tubular member 20.

In some examples, the tubular member 20 define a hollow interior. It is contemplated that the tubular member 20 may have a consistent profile shape along its entire length when viewed from the front or rear. Additionally, the cross-sectional shape of tubular member 20 or the tubular section alone may include, but is not limited to a rectangular shape, a B-shape, a D-shape, a C-shape, or a b-shape. The length of the tubular member 20 may be curved, such as to conform to the front packaging space of a certain vehicle. For example, the tubular member 20 may include various sections along its length with differing degrees of curvature, including relatively straight sections and sections with relatively tight curvatures. The length of the tubular member 20 includes a center portion 22, two end portions 24, and transition portions 26 between the center portion 22 and each of the two end portions 24. In some examples, the profile of the end portion 24 and transition portions 26 is the same as the profile of the center portion 22, when viewed from the front or rear. In other examples, the profile of one or more of the end portions 24, the transition portions 26, or the center portion 22 may have varying profiles.

The cross-sectional shape of the tubular member 20 is formed to generally enclose the hollow interior of the tubular member 20. The tubular member 20 includes a rear wall 49, an upper wall 50, a lower wall 52, and a front wall 47 of the tubular member 20. The front wall 47 forms the front face of the tubular member 20. Impact loads applied to the front face are directed rearward along the upper and lower wall 50, 52 of the tubular member 20.

In some examples, a front wall 47 of the tubular member 20 includes at least one stiffening channel 39 defined therein. The stiffening channel 39 or channels 39 may be configured to provide additional strength and stiffening to the tubular member 20. In some examples, the stiffening channel 39 extends continuously along the length of the tubular member 20. In the example shown, the tubular member 20 includes an upper stiffening channel 39 and a lower stiffening channel 39 disposed approximately equidistant from a center of the front face. However, various other locations have been contemplated. In additional examples, more or less than two stiffening channels 39 may be provided at the front face. Additionally, in the example shown, the stiffening channels 39 have a generally curved profile provided a rounded stiffening channel 39, however, various other configurations have been contemplated including more sharp transitions of the stiffening channels 39 such that a more angular stiffening channel 39 is realized.

In some examples, the rear wall 49 may also be a generally smooth rectangular surface and/or include stiffening features as described above. Moreover, the upper wall 50 and the lower wall 52 may be generally smooth rectangular surfaces extending parallel to one another along the length of the tubular member 20. In some examples, the upper and/or lower wall 52 may include apertures or other features which facilitate the coupling of additional components.

The vehicle beam assembly component 10 may include one or more flanges 18 formed on the beam with the material that the forms the beams. As shown in FIGS. 2D and 2E, the upper and lower flanges 18 extend along a length of the tubular member 20, where the flanges 18 include a folded seem defined by abutting interior surfaces adjacent wall sections of the tubular member. The folded seem terminates at an edge of the flange 18 where the front wall is aligned with and integrally extends into the flange 18. It is also contemplated that one or more flanges may be integrally formed with the vehicle beam component, such that one or more flanges are integral with the vehicle beam component, such as to replace individually attached brackets.

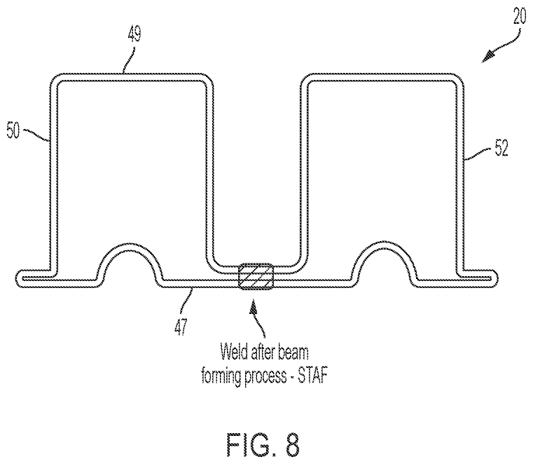

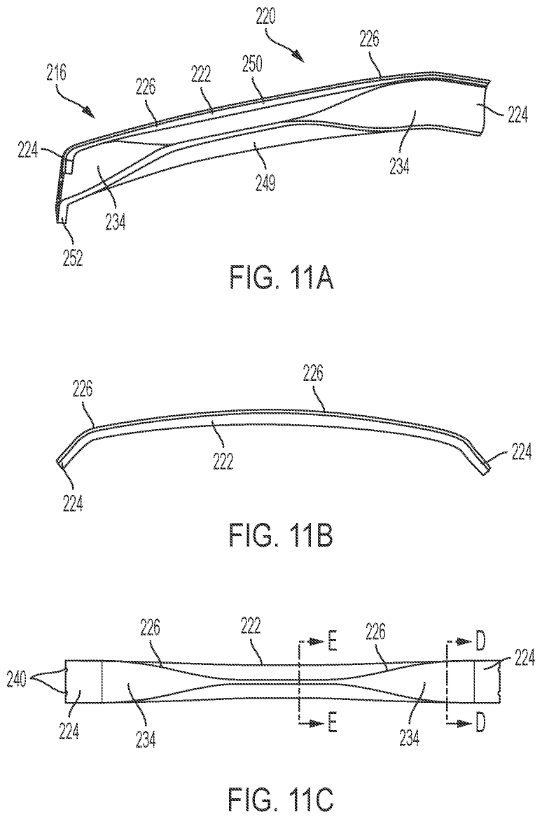

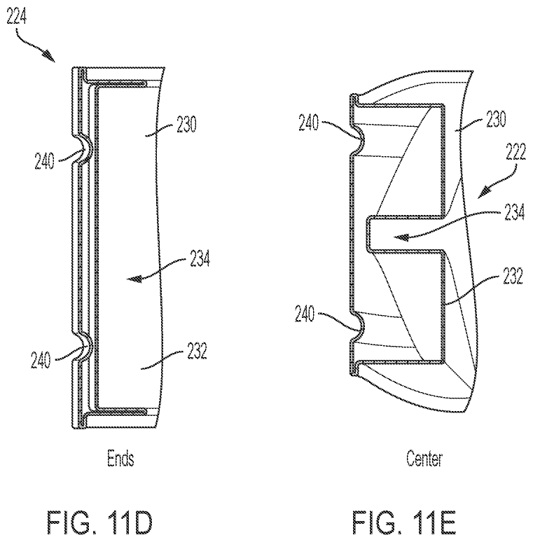

As shown in FIGS. 2A-2E, the hollow tubular member 20 includes a center portion 22 having a first cross-sectional shape and end portions 24 that have a second cross-sectional shape. In some examples, such as shown in FIG. 2E, the first cross-sectional shape is a D shape. In other examples, such as shown in FIG. 8D, the first-cross sectional shape is a B shape. Other first cross-sectional shapes have also been contemplated including but not limited to C orb shapes. The second cross-sectional shape at the end portions 24 is different than the first cross-sectional shape, and in the example shown in FIG. 1D the second cross-sectional shape is a B shape. In additional examples, the end portions 24 may have different cross-sectional shapes, such as a C shape, as shown in FIG. 11D, a D shape, a B shape, a b shape, a d shape, or other conceivable shape or dimensional differences from the cross-sectional shape at the center portion of the beam. Moreover, it is contemplated that one of the end portions 24 may have a different cross sectional shape than the other end portion 24, if desired.

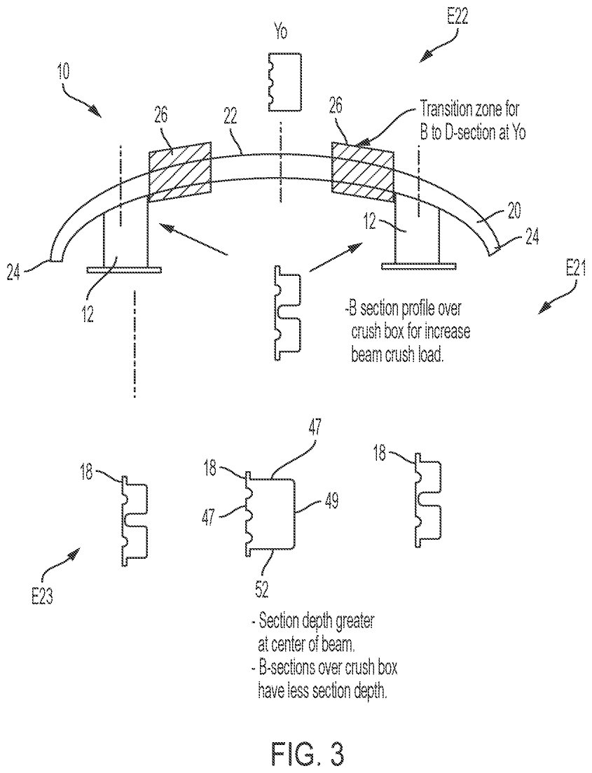

As also shown in FIGS. 2A-2C and 3, the tubular member 20 also includes at least one transition portion 26 disposed between the center portion 22 and the end portions 24. The transition portion 26 includes a third cross-sectional shape or shapes that transitionally interconnect the first and second cross-sectional shapes along the length of the tubular member 20. As such, the cross-sectional shape or shapes along the transition portion 26 may be intermediate transitional shapes that form when altering the cross-sectional profile of a tube between the first and second cross-sectional shapes and thus are similar to the first or second cross-sectional shapes. As shown in FIG. 2C, the transition portion 26 tapers in depth as the beam extends outboard from the D-shape of the center portion 22 to the B-shape of the end portions 24. In addition, as the transition portion 26 extends outboard from the center portion 22, the cross-sectional shape begins to form a recess in the shape of channel 34 at the rear wall to divide the upper portion 30 from the lower portion 32. The channel 34 increases in depth outboard from the center portion 22 simultaneously with the reduction in depth of the overall cross-sectional shape until the base of the channel 34 contacts the front wall of the beam. When the channel 34 contacts and engages the front wall of the beam, the upper portion forms a top tube 30 and the lower portion forms the bottom tube 32 of the tubular member 20. In additional examples, the transition portion and features thereof, including the channel, may vary in depth, width, or other shapes or dimensions at different rates along the length, such as in a linear, an exponential, or a stepped rate in change in formation along the length of the transition portion 26.

The length of the transition portion 26 may depend upon the degree of difference between the cross-sectional shapes interconnected by the transition portion, such as the first and second cross-sectional shapes of the center and end portions 22, 24 shown in FIGS. 2A-2E and 3. The length of the transition portion may also have a length and location along the length of the beam that is tailored for the desired impact energy absorption characteristics at that section. For example, the length of the transition portion may be shorted when the energy absorption characteristics of its profile are undesirable and or alternatively located over the crush cans in such a situation. In addition, it is contemplated that the transition portion may assume a cross-sectional shape that is not an intermediate transitional shape between the first and second cross-sectional shapes. For instance, in one example, the third cross-sectional shape is a C shape. In another example, the third cross-sectional shape is a b shape. In yet another example, the third cross-sectional shape is a B shape. Other second cross-sectional shapes have also been contemplated including but not limited to a D shape or a d shape. Additionally, the transition portion may include at least one recess or channel. The recess may be configured to allow engagement of the crush can or another feature of the vehicle.

As further shown in FIGS. 2A-2E, the tubular member 20 includes end portions 24 having the second cross-sectional shape as a B shape. The end portions 24 include a top tubular member portion 30 and bottom tubular member portion 32 separated by an indented section 34 which forms the B cross-sectional shape (see FIG. 2D). As shown in FIG. 2B, the indented section 34 is disposed on the surface of the tubular member 20 which engages the crush can 12. The tubular member 20 also includes the center portion 22 having a D cross sectional shape such that the indented section 34 does not extend into the center portion 22 (see FIG. 2E). Between the center portion 22 and the end portions 24 is the transition portion 26 which may include a partially indented section 34 that tapers as it extends towards the center portion 22. As described above, the transition portion 26 has a cross sectional shape that is different from both the first cross sectional shape of the center portion 22 and the second cross-sectional shape of the end portions 24. The transition portion 26 may include one or more recessed portions 38 configured to engage one or more other components of the bumper assembly. Additionally, as shown in FIG. 2C the tubular member 20 may include one or more stiffening channels 40 extending across the length of a surface opposite of the surface which engages the crush cans 12 and disposed at the front of the vehicle. In the example shown in FIG. 2B, two stiffening channels 40 extend parallel along the length of the tubular member 20. However, more or less stiffening channels 40 have been contemplated.

As described above, sharp component corners, such as end edges of bumper beams, do not perform well in the MPDB test. Accordingly, the end portions 24 of the tubular member 20 extend past corresponding crush cans 12 in a direction away from the center portion 22, such as shown in FIGS. 2A-6, 9A-9E, and 11A-12E. In other words, at least a portion of a length of the tubular member 20, and more specifically the end portions 24 of the tubular member 20 extend further than the crush cans 12 on either side. Moreover, to further prevent sharp corners, the end portions 24 extend at an angle from the center portion 22, such as to reduce the inaction of the end edges with the impact barrier. In one example, the end portions 24 extend at an angle of approximately 30-80 degrees. In another example, the end portions 24 extend at an angle of approximately 40-70 degrees. In yet another example, the end portions 24 extend at an angle of approximately 50-60 degrees. In yet another example, the end portions 24 extend at an angle of approximately 55 degrees. The end portions 24 may also have a curvature that extends from and through the transition portion to an intermediate area or to the distal end of the end portion.

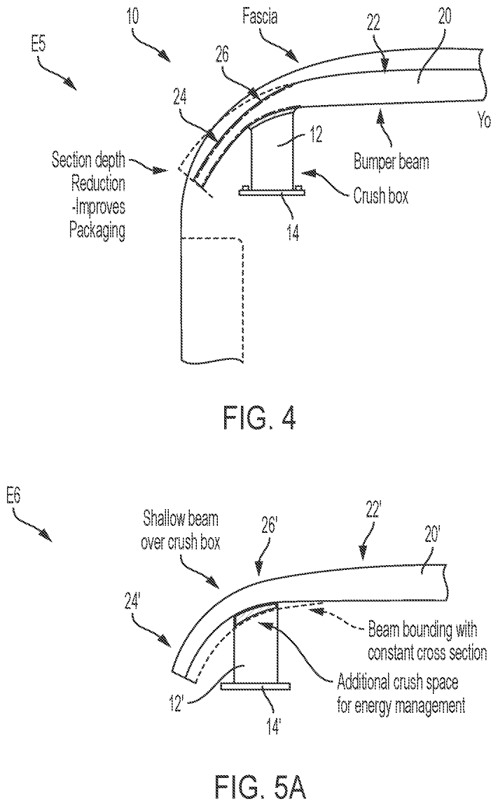

Moreover, as shown in FIG. 4, the end portion 24 of the tubular member includes a reduced depth in comparison to the center portion 22, such that the additional rearward angle and reduced depth at the end portion 24 allows the bumper beam to be packaged within vehicle fascia that would not otherwise permit the packing of a bumper beam having a constant cross-sectional shape along its length, as shown in dashed lines. The depth of the tubular member 20 tapers along the transition portion 26 to provide the reduced section depth at the end portion 24, which has a generally constant depth. The curvature of the tubular member 20 increases from the generally straight center portion 22 to the transition portion 26 and a curvature is present in the end portion 24. It is also contemplated that in some examples that the curvature is present exclusively at the transition portion, such that the end portions are generally straight.

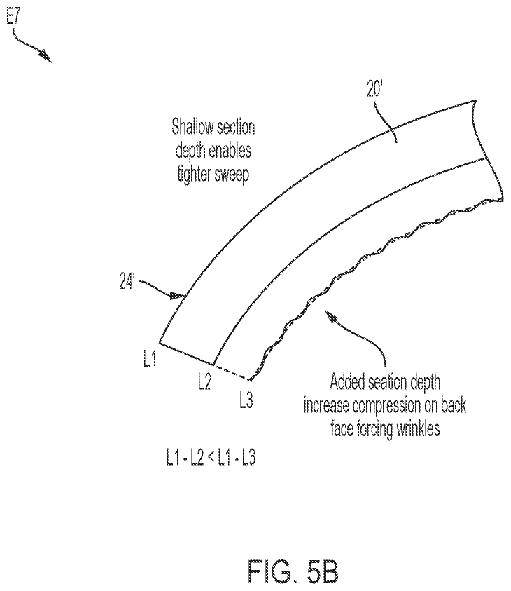

As shown in FIGS. 5A and 5B, the transition portion 26′ similarly has a reduced section depth that tapers outboard from the center portion 22′ toward the end portions 24′. In contrast to the example shown in FIG. 4 where the tapered depth was used to move the front face of the beam at the end portions inboard in the vehicle for allowing the end portions to extend further within the provided packaging space, the example shown in FIGS. 5A and 5B moves the rear face of the tubular member 20′ forward in the vehicle at the transition portion 26′ and end portions 24′ so as to provide additional space for a longer crush can 12′, as shown in FIG. 5A. The longer crush can 12′ increases the available crush stroke by the distance and thereby the increases potential energy absorption at the crush can 12′, which is configured to crush and fail during impact before the vehicle frame 14′ is substantially loaded or subjected to potentially damaging impact forces. Also, such as shown in FIG. 5B, the shallow section depth enables a tighter sweep or increased curvature (i.e., a smaller radius of curvature) at the end section. The depth difference is illustrated in FIG. 5B as shown between L2 and L3, showing that a rear wall without the reduced section depth at L3 effectively has a greater compressive forces than the rear wall at L2, while each maintain the same curvature at the front wall of the beam. The greater compressive forces at the rear wall with a section depth of L3 is shown to cause sheet wrinkling, which is generally undesirable.

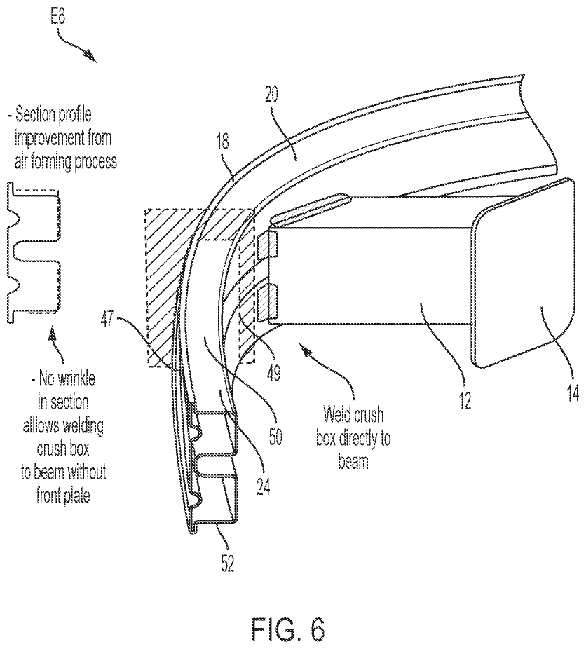

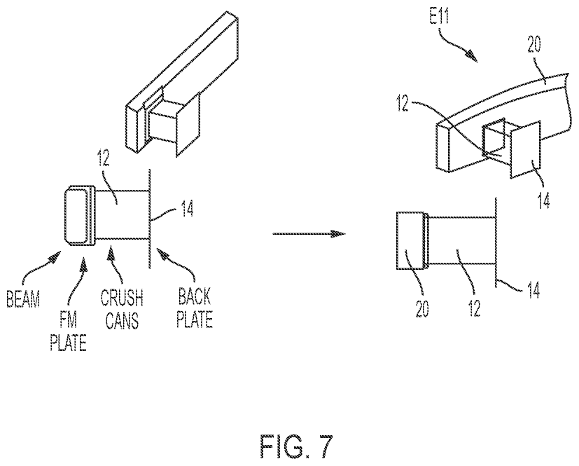

As shown in FIG. 6, the rear face of the bumper tubular member 20 formed with the STAF process is generally void of wrinkling or bowing, which is commonly caused by bending a beam in a post-forming operation, such as a sweep unit or an off-line bender. By providing the bumper tubular member 20 without such wrinkles or bowing, the rear face of the beam is generally planar and thereby an effective surface for welding. As illustrated in FIG. 6, the crush can is welded directly to the rear face of the beam, omitting an interface plate that is commonly used with roll formed beams and thereby eliminating the weight and processing requirements for the interface plate. Also, as shown in FIG. 7, the example shows the crush can 12 is directly welded to the tubular member 20, omitting the front plate previously attached as an interface plate between the front of the crush can and the beam.

After the STAF forming process, in some examples, a weld may be provide to further strengthen the tubular member 20. For example, as shown in FIG. 8, a weld may be provided in the channel or indented section 34 to connect the rear wall to the front wall at intermediate locations along the length of the tubular member 20 or continuously along the length of the tubular member 20.

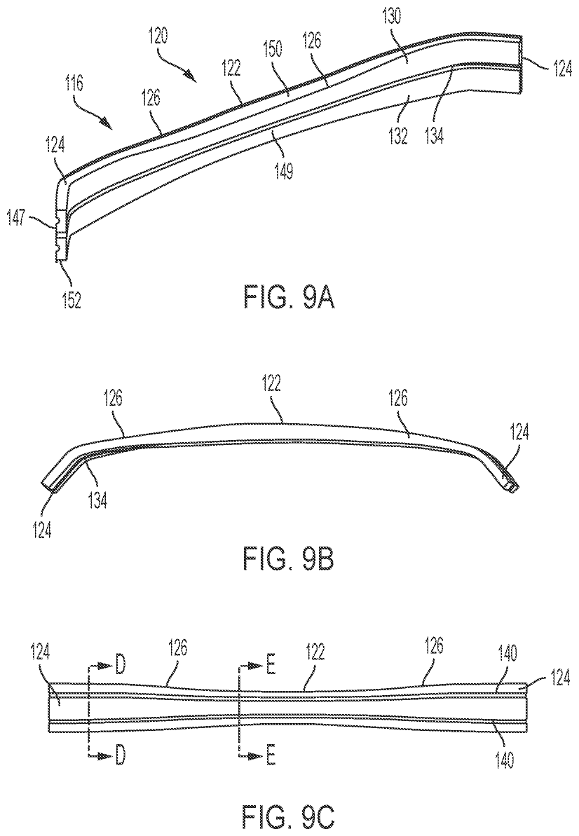

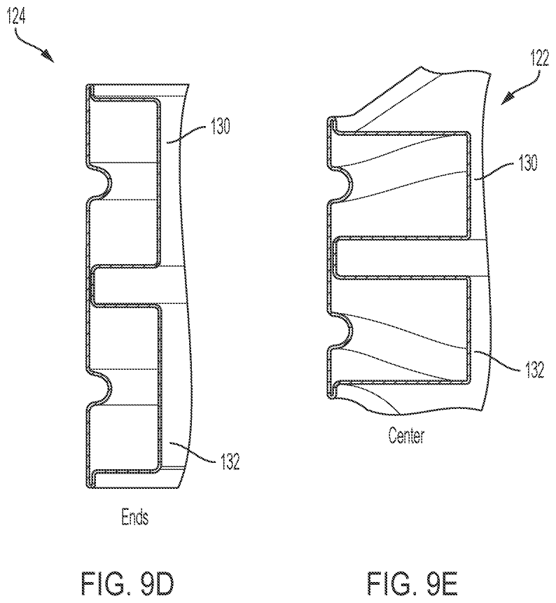

Referring now to the example shown in FIGS. 9A-9E, the tubular member 120 includes end portions 124 having the second cross-sectional shape as a B shape. The end portions 124 include the top tubular member portion 130 and the bottom tubular member 132 separated by the indented section 134 which forms the B cross-sectional shape (FIG. 9D). As shown in FIG. 9B, the indented section 134 is disposed on the side of the tubular member 120 which engages the crush can 112. Referring still to the example shown in FIGS. 9A-9E, the tubular member 120 also includes the center portion 122 having a B cross sectional shape. In the example shown in FIGS. 9A-9C, the indented section 134 extends the entire length of the tubular member 120. However, the indented section 134 varies in depth along the length to follow the overall depth of the beam, which as shown in FIG. 9B in greater at the center portion and shallower at the end portions. As shown in FIG. 9D, the end portions 124 having the B cross sectional shape is taller and the indented sections 134 defined in end portions 124 of the tubular member are shallower than in the center portion 122. Additionally, as shown in FIG. 9E, the center portion 122 B shape is shorter than the end portions 124 and the indented section 134 is defined deeper within the center portion 122. Between the center portion 122 and the end portions 124 is the transition portion 126 which may include a height which transitions from the taller height of the end portions 124 to the shorter height of the center portion 122. Additionally, the transition portion 126 transitions from the more shallow indented sections 134 of the end portions 124 to the deeper indented section 134 of the center portion 122. As described above, the transition portion 126 has a cross sectional shape that is different from both the first cross sectional shape of the center portion 122 and the second cross-sectional shape of the end portions 24. The transition portion 126 may also include one or more recessed portions configured to engage one or more other components of the vehicle frame.

Additionally, as shown in FIG. 9C the tubular member 120 may include one or more stiffening channels 140 extending across the length of a side opposite of the side which engages the crush can 112 and disposed at the front of the vehicle. In the example shown in FIG. 9C, two stiffening channels 140 extend parallel along the length of the tubular member. However, more or less stiffening channels 140 have been contemplated.

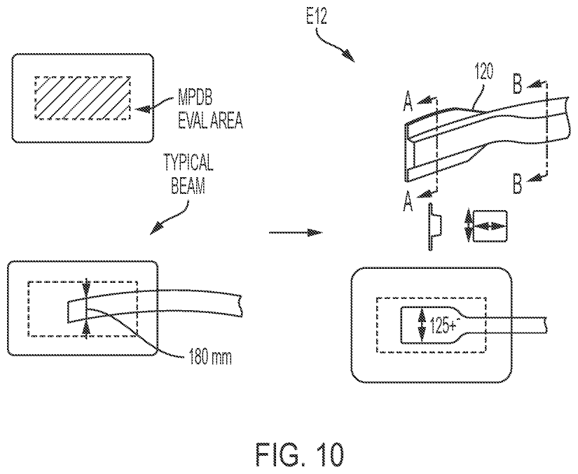

Moreover, as shown in FIG. 10, the tubular member 120 is show impacting a barrier in a MPDB impact test with a larger interfacing surface area than the surface area of a beam having a constant cross section along its length. The larger front face of the beam 120 is provided at least in part by an upper flange and a lower flange of the beam 120.

Referring now to the example shown in FIGS. 11A-11E, the tubular member 220 includes end portions 224 having the second cross-sectional shape as a C shape. Similar to the examples described above, the tubular member 220 includes the indented section 234. However, in the example shown in FIGS. 11A-11E the indented section 234 extends the width of the end portions 224 forming a C cross sectional shape (FIG. 11D). As shown in FIG. 11B, the indented section 234 is disposed on the side of the tubular member 220 which engages the crush cans 212. Referring still to the example shown in FIGS. 11A-11E, the tubular member also includes the center portion 222 having a B cross sectional shape. In the example shown in FIGS. 11A-11C, the indented section 234 extends the entire length of the tubular member 220. However, the indented section 234 varies in width along the length. As shown in FIG. 11C, in the end portions 224 having the C cross sectional shape is taller and the indented sections 234 defined in end portions 224 of the tubular member 220 are shallower than the indented section 234 is wider at the end portions 224 and tapers inward at the transition portion 226 towards the center portion 222. Additionally, the indented section 234 is thinner at the center portion 222 compared to the end portion 224. Between the center portion 222 and the end portions 224 is the transition portion 226 which may include a tapered width of the indented section 234 which begins at the width of the end portions 224 before tapered towards the width of the indented section 34 in the center portion 222. As described above, the transition portion 226 has a cross sectional shape that is different from both the first cross sectional shape of the center portion 222 and the second cross-sectional shape of the end portions 224. The transition portion 226 may also include one or more recessed portions configured to engage one or more other components of the vehicle frame. Additionally, as shown in FIG. 11C the tubular member 220 may include one or more stiffening channels 240 extending across the length of the front side. In the example shown in FIG. 11C, two stiffening channels 240 extend parallel along the length of the tubular member 220. However, more or less stiffening channels 240 have been contemplated.

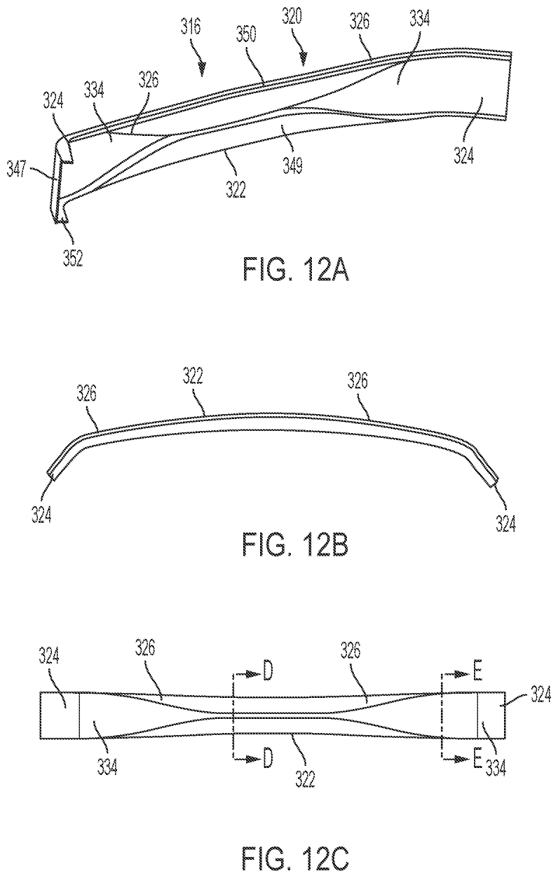

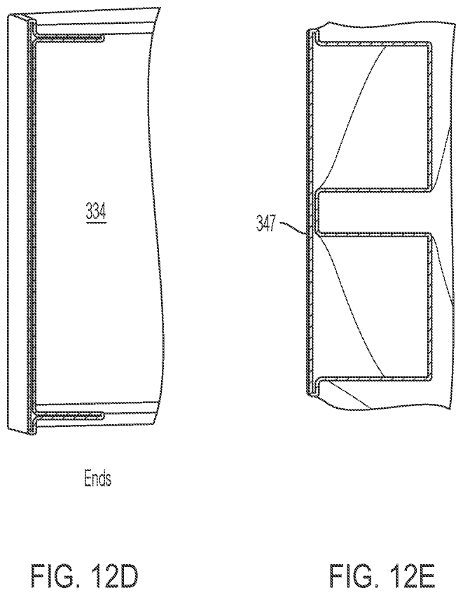

Referring now to the example shown in FIGS. 12A-12E, the tubular member 320 may have end portions 324, a center portion 322, and indented sections 334 as described above with respect to FIGS. 11A-1E. However, the example shown in FIGS. 12A-12E does not include stiffening channels on the front surface and the front surface is a continuous generally flat surface along the lengths, covering the end portions 24 and the center portion 22.

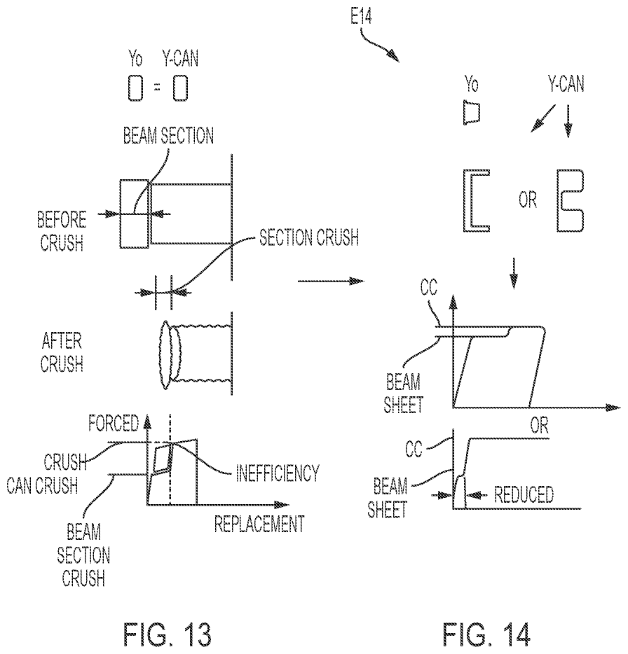

As discussed above with reference to FIGS. 5A and 7, the beam may be directly attached to the crush cans, such as to eliminate interface plates and increase potential energy absorption by lengthening the crush can. It may also be advantageous in some examples to configure the engagement portions of the beam that attach to the crush cans to further improve energy absorption, such as by providing an recessed area at the rear side of the beam to receive the crush can. As shown for example in FIGS. 13 and 14 the use of a beam with a rectangular cross section at the crush can attachment may result in some inefficiency of energy absorption during impact. This inefficiency may be resolved by reducing the effective depth of the beam at the crush can engagement, such as with a reduced depth as shown in FIG. 5A or an alternative section, for instance a C-shaped section as shown in FIGS. 11A-11E, 12A-12E, and 14.

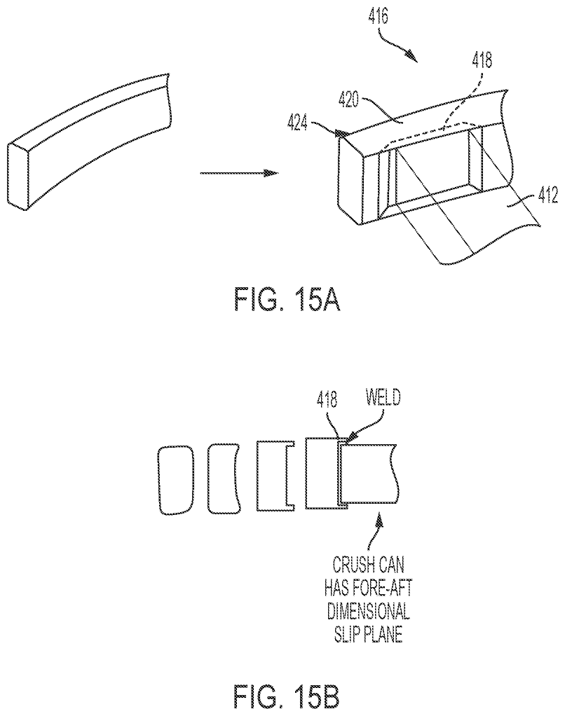

As illustrated in FIGS. 15A and 15B, the tubular member 416 may also or alternatively include integrally formed crush can attachment features at select areas of the end portions 424 of the tubular member. As shown in FIGS. 15 and 16, the end sections of the tubular member include recessed surfaces at the back side of the beam to receive the crush can 412. Such a recessed area may also result in flanges 418 being formed above and below the recessed surface. The flanges may also be used to provide a surface with an improved weld condition for attaching the crush can.

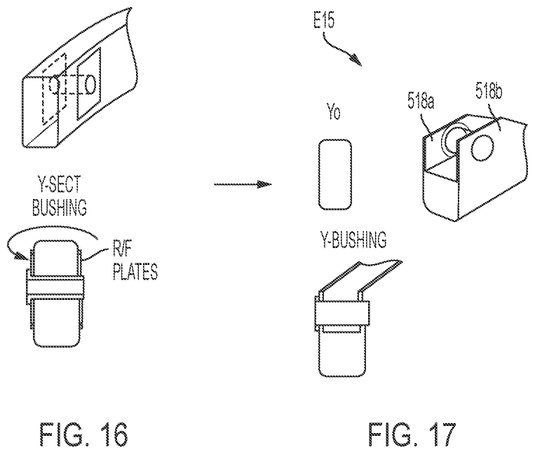

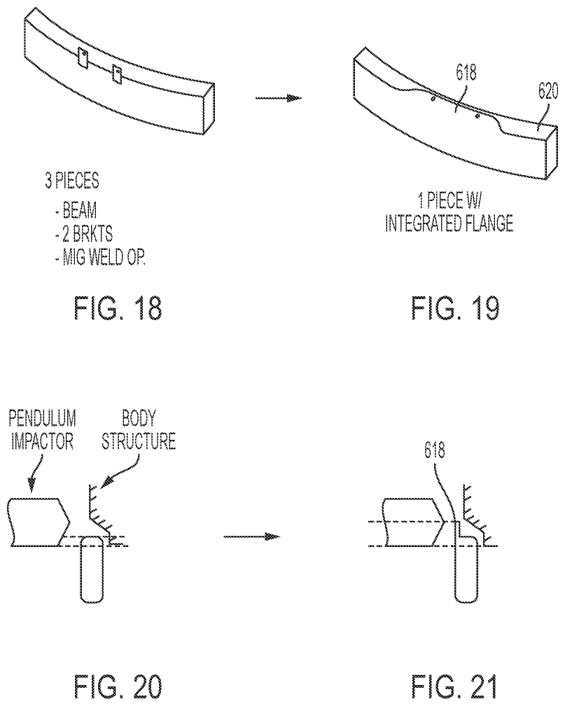

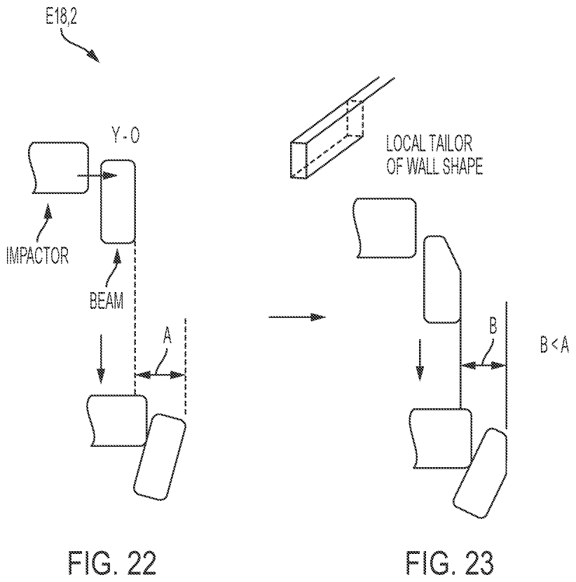

Also, in some examples, the tubular member may include at least one local deformation at a select section along the length of the beam. In some examples, such as shown in FIG. 17, the deformation at the top wall provided between a front flange 518a and a rear flange 518b provides front and rear mounting surfaces for a tow hook bushing. In doing this, front and rear plates used to hold a bushing in a beam may be generally omitted. Similarly, as shown in FIG. 19, a front flange 618 may be integrally disposed on the beam 620 and extend upward from the front face in a manner that allows brackets to be omitted, such as shown in FIG. 18. Such a front flange 618 may provide an improved energy absorption by the top wall of the beam, as shown in FIG. 21 in comparison with FIG. 20. In additional examples, the beam has local tailoring, such as with an angled shape to the wall as shown in FIG. 23, to provide improved impact absorption, such as improved from FIG. 22.

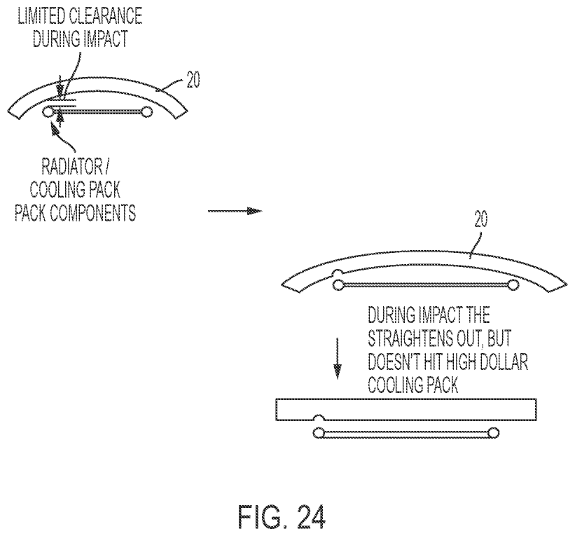

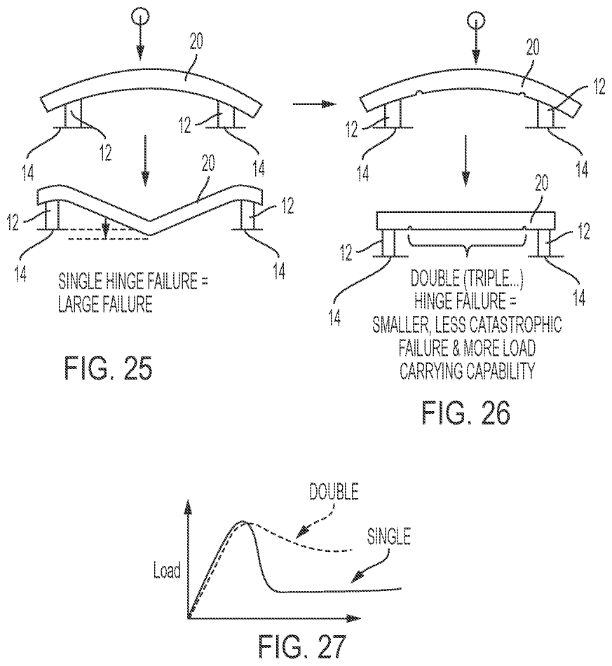

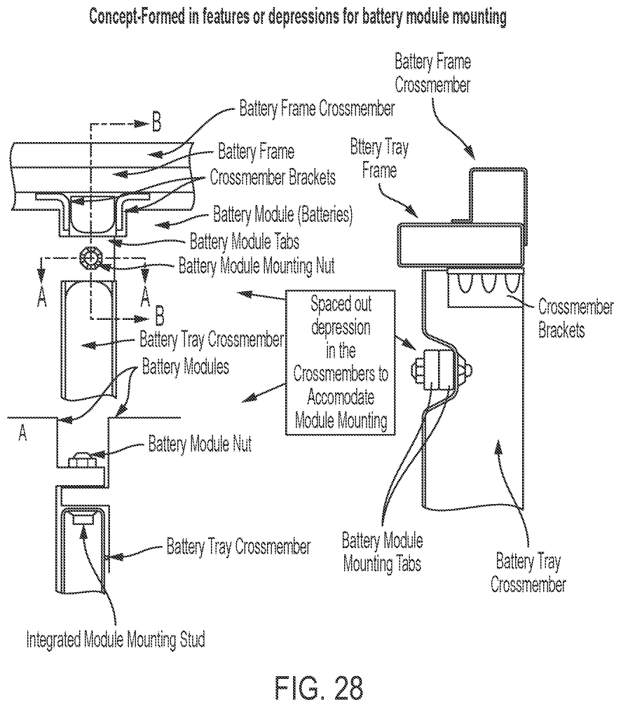

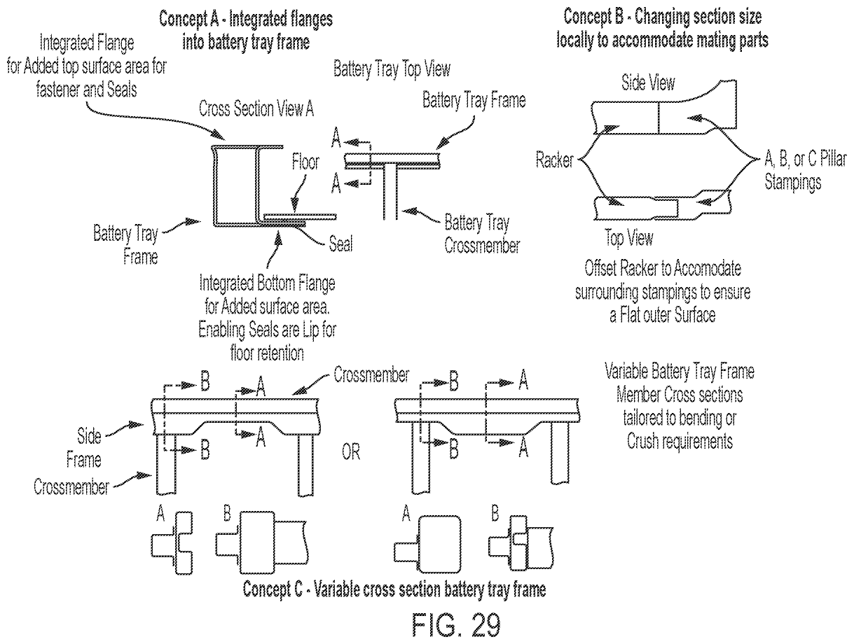

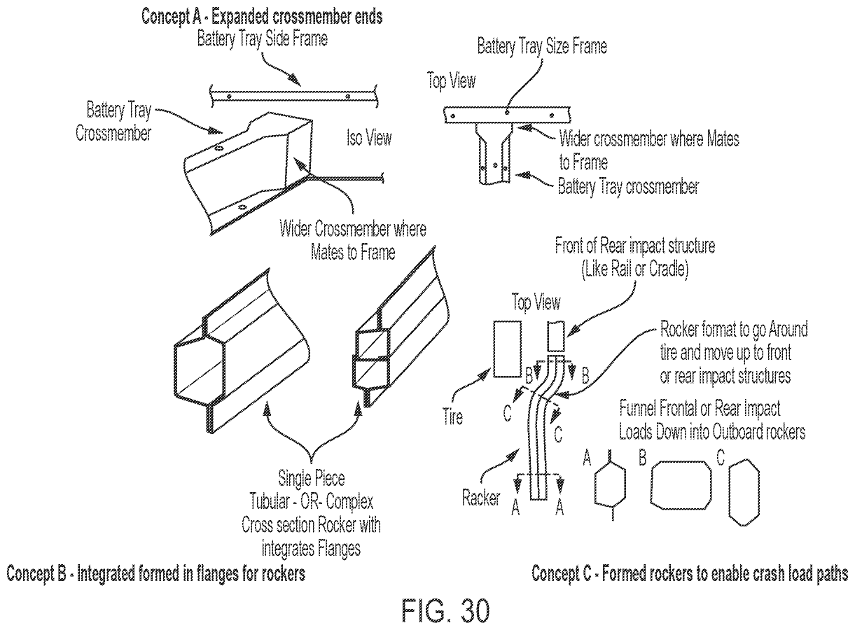

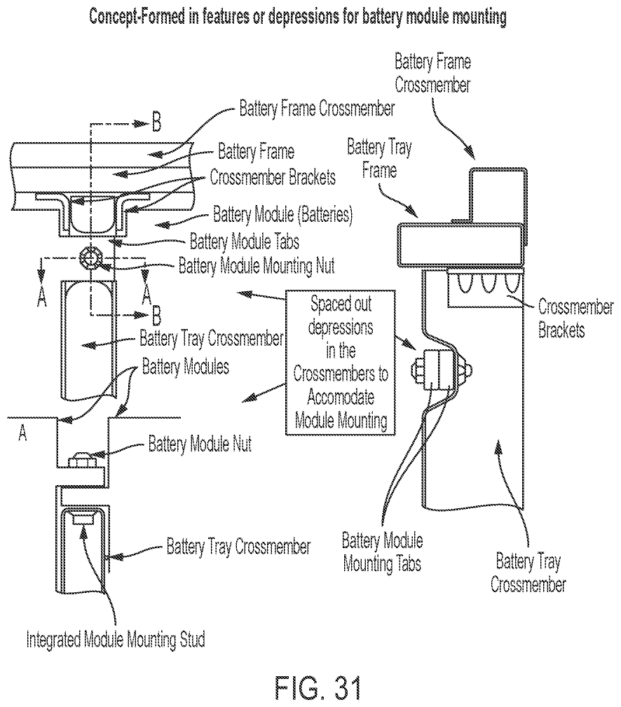

Moreover, the local deformation may provide clearance for adjacent vehicle components during crush caused by impact. For example, as shown in FIG. 24, a local deformation is provided at the section of the beam for conforming to the radiator or cooling pack. In addition, as shown in FIG. 26, a local deformation may provide features at select locations that control or initiate deformation during impact, such as to cause the beam to deform as hinge and provide a resulting beam shape desirable for contact an object, such as an object or a deformable barrier or the like, providing energy absorption improvements over a single hinge failure as shown in FIGS. 25 and 27.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

Also for purposes of this disclosure, the terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A vehicle beam assembly comprising:
a pair of crush cans configured to be coupled to a vehicle frame; and
a hollow tubular member coupled to the pair of crush cans and configured to be formed with a steel tube air forming process, wherein the tubular member includes a varied cross section along a length of the tubular member, and wherein the hollow tubular member comprises:
a center portion having a first cross-sectional shape;
a pair of end portions that extend outward from the pair of crush cans in a direction away from the center portion; and
at least one transition portion disposed between the center portion and one of the pair of end portions, wherein a cross-sectional shape of the center portion, a cross sectional shape of one of the end portions, and a cross-sectional shape of the transition portion are all different cross-sectional shapes.

2. The vehicle beam assembly of claim 1, wherein the pair of end portions extend rearward from the center portion at an angle of 40-70 degrees.

3. The vehicle beam assembly of claim 1, wherein the end portions of the tubular member have a narrowed depth relative to the center portion of the tubular member.

4. The vehicle beam assembly of claim 1, wherein the tubular member includes integrally formed crush can attachment features at select end portions of the tubular member.

5. The vehicle beam assembly of claim 4, wherein the attachment features includes recessed areas at a back side of the vehicle beam assembly component to receive the crush cans.

6. The vehicle beam assembly of claim 4, wherein the tubular member includes an integral flange adjacent to the recessed areas, and wherein the integral flange is disposed against the crush cans for providing a weld interface.

7. The vehicle beam assembly of claim 1, wherein the tubular member comprises an integrated flange disposed along the length of the tubular beam, wherein the integrated flange comprises a folded seem defined by abutting interior surfaces of adjacent wall sections of the tubular member, and wherein the folded seem terminates at an edge of the integrated flange where the adjacent wall sections integrally interconnect to enclose a hollow interior of the tubular member.

8. The vehicle beam assembly of claim 1, cross-sectional shapes of the tubular member at the end portions and center portion each include a rear wall portion, an upper wall portion, a lower wall portion, and a lower wall portion that interconnect with each other to enclose a.

9. The vehicle beam assembly of claim 1, wherein the cross-sectional shape of the end portion includes a C shape and the cross-sectional shape of the center portion includes a B shape.

10. The vehicle beam assembly of claim 1, wherein the cross-sectional shape of the end portion includes a B shape and the cross-sectional shape of the center portion includes a D shape.

11. A vehicle beam assembly component configured to be formed with steel tube air forming, the vehicle beam assembly component comprising:
a hollow tubular member formed from a high-strength steel and having an integrated flange extending along a length of the tubular member;
wherein the integrated flange includes a folded seem defined by abutting interior surfaces of adjacent wall sections of the tubular member; and
wherein the folded seem terminates at an edge of the integrated flange where the adjacent wall sections integrally interconnect.

12. The vehicle beam assembly component of claim 11, wherein the tubular member includes integrally formed crush can attachment features at select end sections of the tubular member.

13. The vehicle beam assembly component of claim 12, wherein the attachment features includes recessed areas at a back side of the vehicle beam assembly component to receive a crush can.

14. The vehicle beam assembly component of claim 11, wherein the tubular member includes a center portion and a pair of end portions that extend rearward at an angle of 40-70 degrees, and wherein the end portions of the tubular member are formed with a narrowed depth relative to the center portion of the tubular member.

15. The vehicle beam assembly component of claim 14, wherein a cross sectional shape of the end portions and a cross-sectional shape of the center portion are different cross-sectional shapes.

16. The vehicle beam assembly component of claim 11, wherein the tubular member includes local deformation at a select section along the length of the tubular member, and wherein the local deformation includes a crush initiator configured to cause the vehicle beam assembly component to deform as a hinge.

17. The vehicle beam assembly of claim 11, wherein the tubular member comprises a battery tray component or a rocker component.

18. A vehicle beam assembly component comprising:
a hollow tubular member configured to be formed with a steel tube air forming process, wherein the tubular member includes a varied cross section along a length of the tubular member, and wherein the hollow tubular member comprises:
a center portion having a first cross-sectional shape;
a pair of end portions that extend outward from the center portion; and
at least one transition portion disposed between the center portion and one of the pair of end portions, wherein a cross-sectional shape of the center portion, a cross sectional shape of one of the end portions, and a cross-sectional shape of the transition portion are all different cross-sectional shapes,
wherein the tubular member comprises an integrated flange disposed along the length of the tubular beam,
wherein the integrated flange comprises a folded seem defined by abutting interior surfaces of adjacent wall sections of the tubular member, and
wherein the folded seem terminates at an edge of the integrated flange where the adjacent wall sections integrally interconnect.

19. The vehicle beam assembly component of claim 18, wherein the pair of end portions extend rearward from the center portion at an angle of 40-70 degrees.

20. The vehicle beam assembly component of claim 18, wherein the end portions of the tubular member are formed with a narrowed depth relative to the center portion of the tubular member.
